(19) United States
(12) Patent Application Publication
(10) Pub. No.: US 2025/0006914 A1
(43) Pub. Date: Jan. 2, 2025

(54) POSITIVE ELECTRODE PIECE AND LITHIUM-ION BATTERY

(71) Applicant: Zhuhai CosMX Battery Co., Ltd., Zhuhai (CN)

(72) Inventor: Fan YANG, Zhuhai (CN)

(21) Appl. No.: 18/665,344

(22) Filed: May 15, 2024

(30) Foreign Application Priority Data
Jun. 28, 2023 (CN) 202310776457.0

(51) Int. Cl. H01M 4/525; H01M 4/02; H01M 4/131; H01M 10/0525; H01M 10/42; H01M 50/383

(52) U.S. Cl. CPC H01M 4/525; H01M 4/131; H01M 10/0525; H01M 10/4235; H01M 50/383; H01M 2004/021; H01M 2004/028

(57) ABSTRACT

The present disclosure provides a positive electrode piece and a lithium-ion battery. The positive electrode piece includes: a positive electrode current collector, a first coating layer disposed on at least one surface of the positive electrode current collector, and a positive electrode active material layer disposed on a surface of the first coating layer, where the first coating layer contains a first material and a conductive agent, a particle diameter of the first material is ≤800 nm, and a sheet resistance of the first coating layer is not less than 500 mΩ/□. The positive electrode piece provided by the present disclosure can improve the impedance of a contact short-circuit site between the positive electrode current collector and a negative electrode active material, and reduce the heat generated by the short circuit, thereby effectively reducing safety problems such as battery cell catching fire caused by the short circuit.

### CROSS-REFERENCE TO RELATED APPLICATION

The present application claims priority to Chinese Patent Application No. 202310776457.0, filed with China National Intellectual Property Administration on Jun. 28, 2023. The disclosure of the aforementioned application is hereby incorporated by reference in its entirety.

### TECHNICAL FIELD

The present disclosure belongs to the technical field of lithium-ion batteries, and in particular, relates to a positive electrode piece and a lithium-ion battery.

### BACKGROUND

Lithium-ion batteries have no memory effect and have high capacity, good cycling performance and other advantages, and are widely used in consumer digital products, travelling tools, energy storage devices and other scenarios.

However, when lithium-ion batteries encounter mechanical abuse such as squeezing, impacting and nail-penetration during use, a large amount of Joule heat will be produced, which triggers chemical reactions within lithium-ion batteries to further release heat and ignite combustibles, resulting in lithium-ion batteries catching fire, and non-negligible safety problems.

Generally speaking, when lithium-ion batteries encounter mechanical abuse, four short-circuit modes may occur in battery cells of lithium-ion batteries: contact short-circuit between a positive electrode active material and a negative electrode active material, contact short-circuit between a positive electrode active material and a negative electrode current collector, contact short-circuit between a positive electrode current collector and a negative electrode active material, and contact short-circuit between a positive electrode current collector and a negative electrode current collector. Among them, when the positive electrode current collector is contacted with the negative electrode active material, since short-circuit resistance is small and heat generation is concentrated in a short-circuit site, short-circuit site is instantaneous exothermic and temperature increases suddenly, which is very easy to cause internal materials of batteries to catch fire. Therefore, the contact short-circuit between the positive electrode current collector and the negative electrode active material is the most likely mode of short-circuit.

### SUMMARY

The present disclosure provides a positive electrode piece, which can improve the impedance of a contact short-circuit site between a positive electrode current collector and a negative electrode active material, and reduce the heat generated by the short circuit, thereby effectively reducing safety problems such as battery cell catching fire caused by the contact short-circuit between the positive electrode current collector and the negative electrode active material, and minimizing the influence on the electrochemical performance and energy density of the lithium-ion battery while ensuring the safety performance.

The present disclosure further provides a battery cell, which has a high contact short-circuit impedance between the positive electrode current collector and the negative electrode active material, so that the heat generated by the contact short-circuit between the positive electrode current collector and the negative electrode active material can be reduced, thereby effectively reducing the safety problems such as battery cell catching fire caused by the contact short-circuit between the positive electrode current collector and the negative electrode active material.

The present disclosure further provides a lithium-ion battery, which has a high contact short-circuit impedance between the positive electrode current collector and the negative electrode active material, so that the heat generated by the contact short-circuit between the positive electrode current collector and the negative electrode active material can be reduced, thereby effectively reducing the safety problems such as battery cell catching fire caused by the contact short-circuit between the positive electrode current collector and the negative electrode active material.

In a first aspect, the present disclosure provides a positive electrode piece, including: a positive electrode current collector, a first coating layer disposed on at least one surface of the positive electrode current collector, and a positive electrode active material layer disposed on a surface of the first coating layer;
the first coating layer contains a first material and a conductive agent, where a particle diameter of the first material in the first coating layer is ≤800 nm; and a sheet resistance of the first coating layer is not less than 500 μmΩ/□.

The positive electrode piece as described above, where the particle diameter Dv50 of the first material is ≤400 nm, and as an embodiment, the particle diameter Dv50 of the first material satisfies: 10 nm≤Dv50≤80 nm; and/or, the sheet resistance of the first coating layer is not less than 800 mΩ/□; and/or, the sheet resistance of the first coating layer is ≤13000 mΩ/□; as an embodiment, the sheet resistance of the first coating layer is ≤4000 mΩ/□.

In the positive electrode piece as described above, a resistivity of the first material is greater than or equal to 1 Ω·cm

In the positive electrode piece as described above, in the first coating layer, a mass ratio of the first material is ≥30%, and a mass ratio of the conductive agent is ≤20%.

In the positive electrode piece as described above, the first coating layer further contains a first binder, and a content of the first binder in the first coating layer is greater than or equal to 15 wt % and less than or equal to 70 wt %.

In the positive electrode piece as described above, a thickness of the first coating layer in the electrode piece is not greater than 1 μm.

In the positive electrode piece described above, the positive electrode active material layer contains a second material, a second binder and a second conductive agent; where a resistivity of the second material is greater than or equal to 1 Ω·cm.

In the positive electrode piece described above, the first material is selected from at least one of: aluminum oxide, barium sulfate, silicon dioxide, silicon monoxide, zirconium oxide, magnesium oxide, vanadium oxide, titanium oxide, boehmite, which are carbon-coated or non-carbon-coated; carbon-coated or non-carbon-coated lithium iron manganese phosphate; and carbon-coated or non-carbon-coated lithium titanate.

In the positive electrode piece described above, the second material is selected from at least one of: aluminum oxide, barium sulfate, silicon dioxide, silicon monoxide, zirconium oxide, magnesium oxide, vanadium oxide, titanium oxide, boehmite, which are carbon-coated or non-carbon-coated; carbon-coated or non-carbon-coated lithium iron manganese phosphate; and carbon-coated or non-carbon-coated lithium titanate; and/or,
the positive electrode active material includes at least one of lithium cobaltate, lithium iron phosphate, lithium nickelate, lithium manganate, lithium titanate, lithium vanadate, lithium manganese phosphate, lithium manganese iron phosphate, lithium vanadium phosphate, lithium oxyvanadium phosphate, lithium-rich manganese material, nickel-cobalt-manganese ternary material, nickel-cobalt-aluminum ternary material and nickel-cobalt-manganese-aluminum material.

In the positive electrode piece described above, a content of the second binder in the positive electrode active material layer is 0.5-5 wt %;
a content of the second material in the positive electrode active material layer is greater than or equal to 0.8 wt %; and
a content of the second conductive agent in the positive electrode active material layer is 0.3-3 wt %.

In a second aspect, the present disclosure provides a lithium-ion battery, including the positive electrode piece according to the first aspect.

The lithium-ion battery as described above further includes a negative electrode piece, the negative electrode piece includes a negative electrode current collector; and a first negative electrode active layer and a second negative electrode active layer which are located on at least one surface of the negative electrode current collector, and the first negative electrode active layer is located between the second negative electrode active layer and the negative electrode current collector; a particle diameter of a negative electrode active material in the first negative electrode active layer is larger than a particle diameter of a negative electrode active material in the second negative electrode active layer.

Implementation of the present disclosure has at least the following beneficial effects:

When the positive electrode piece provided by the present disclosure encounters mechanical abuse, the first coating layer can still be reserved on the surface of the aluminum foil in the process that the positive electrode active material layer is peeled off, so that the positive electrode current collector can be effectively prevented from being contacted with the negative electrode active material to generate a short circuit; and even if the first coating layer is contacted with the negative electrode active material layer to generate a short circuit, since the first material in the first coating layer is limited to be nano-scale particles, it is conducive to reducing a thickness of the first coating layer, thereby preventing the first coating layer from being too thick to effect the energy density of the battery; and meanwhile, the thinner the first coating layer is, the more uniformly and evenly the first material in the first coating layer is coated, thereby being conducive to minimizing the influence on the electrical performance and energy density of the lithium-ion battery while ensuring the safety performance.

### BRIEF DESCRIPTION OF DRAWINGS

FIG. 1 is a structural schematic diagram of a positive electrode piece according to an embodiment of the present disclosure.

FIG. 2 is a SEM graph of a cross-section of a first coating layer in a positive electrode piece according to an embodiment of the present disclosure.

FIG. 3 is a SEM graph of a surface of a first coating layer in a positive electrode piece according to an embodiment of the present disclosure.

### DESCRIPTION OF REFERENCE NUMERALS

1: positive electrode current collector; 2: first coating layer; 21: first material; 3: positive electrode active material layer; 31: second material.

### DESCRIPTION OF EMBODIMENTS

In order to make the objects, technical solutions and advantages of the present disclosure clearer, the technical solutions in the embodiments of the present disclosure will be described clearly and completely in combination with the examples of the present disclosure. Obviously, the described examples are some of the examples of the present disclosure, not all of the examples. Based on the examples in the present disclosure, all other examples obtained by those of ordinary skill in the art without creative work belong to the protection scope of the present disclosure. In the description of the present disclosure, unless otherwise clearly defined and limited, terms “first”, “second”, etc. are merely used for descriptive purposes, such as for distinguishing the composition of coating layers, so as to more clearly illustrate/explain the technical solutions, and shall not be understood to indicate or imply the number or an order having substantive significance, of technical features indicated, etc.

The term “about” as used herein is as understood by one of ordinary skill in the art and varies to some extent depending on the context in which it is used. If the use of the term is not understood by one of ordinary skill in the art from the context in which it is used, “about” will mean up to 10% above or below a specific value.

A first aspect of the present disclosure provides a positive electrode piece. As shown in FIG. 1, the positive electrode piece includes: a positive electrode current collector 1, a first coating layer 2 disposed on at least one surface of the positive electrode current collector 1, and a positive electrode active material layer 3 disposed on a surface of the first coating layer 2; where the first coating layer contains a first material and a conductive agent, and in the first coating layer, a particle diameter of the first material is ≤800 nm, and a sheet resistance of the first coating layer is not less than 500 mΩ/□.

Specifically, a particle diameter of the first material is =800 nm, that is, a median particle diameter of the first material is: Dv50≤800 nm, further Dv50≤400 nm, and further 10 nm≤Dv50≤80 nm. For example, the median particle diameter of the first material Dv50 is 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 10 nm, or a range consisting of any two thereof.

According to the research of the present disclosure, application of the positive electrode piece to a battery can minimize the influence on the electrical performance and energy density of the lithium-ion battery while ensuring the safety performance. This is because that in the present application, by setting the first coating layer and limiting a particle size of the first material, it is conducive to reducing a thickness of the first coating layer, thereby preventing the first coating layer from being too thick to effect the energy density of the battery; and meanwhile, the thinner the first coating layer is, the more uniformly and evenly the first material in the first coating layer is coated; furthermore, by limiting a sheet resistance of the first coating layer, it is conducive to greatly improving mechanical abuse problems such as nail-penetration and squeezing, and thus conducive to minimizing the influence on the electrical performance and energy density of the lithium-ion battery while ensuring the safety performance.

The first material has low conductivity, which is conducive to realizing that the sheet resistance of the first coating layer is not less than 800 mΩ/□, and thus conducive to greatly improving mechanical abuse problems such as nail-penetration and squeezing. The sheet resistance may also be referred to as square resistance.

In order to balance the electrical conductivity and safety of the positive electrode piece, in some embodiments, the sheet resistance of the first coating layer is ≤13000 mΩ/□. For example, the sheet resistance of the first coating layer is 500 mQ/0, 800 mΩ/□, 1000 mΩ/□, 1500 mΩ/□, 2000 mΩ/□, 2500 mΩ/□, 3000 mΩ/□, 4000 mΩ/□, 5000 mΩ/□, 6000 mΩ/□, 7000 mΩ/□, 8000 mΩ/□, 10000 mΩ/□, 13000 mΩ/□, or a range consisting of any two thereof. As an embodiment, the sheet resistance of the first coating layer is ≤5000 mΩ/□, and as another embodiment the sheet resistance of the first coating layer is ≤4000 mΩ/□.

When mechanical abuse occurs, in the process that the positive electrode active material layer 3 is peeled off, since the first material contained in the first coating layer 2 has a high sheet resistance, the positive electrode current collector 1 can be effectively prevented from being contacted with the negative electrode active material to generate a short circuit, and even if a contact short-circuit occurs, the first coating layer 2 can effectively reduce the heat generated by short-circuit.

In the first coating layer, a mass ratio of the first material is ≥30%, and a mass ratio of the conductive agent is ≤20%. A content of the first material in the first coating layer is greater than or equal to 30 wt %; a content of the conductive agent in the first coating layer is greater than or equal to 1% and less than or equal to 12%.

As an embodiment, the first coating layer contains a first binder, a content of the first binder in the first coating layer is greater than or equal to 15 wt % and less than or equal to 70 wt %. The first binder in the content range has strong adhesive property, so that the first coating layer can be firmly fixed on at least one surface of the positive electrode current collector, and the first coating layer is not easy to be peeled off from the positive electrode current collector when mechanical abuse occurs. Even if the thickness of the first coating layer is not greater than 1 μm, the first coating layer is not easy to be broken into a plurality of fragments, which is conducive to improving the impedance of a short-circuit site and reducing the heat generated by the short circuit. Meanwhile, the thickness of the first coating being not greater than 1 μm may also not lose the energy density of the battery and balance the energy density and the safety performance.

As an embodiment, as shown in FIG. 1, the first coating layer 2 contains a first material 21, the resistivity of the first material is greater than or equal to 1 Ω·cm. This is because that the material with this resistivity has a better insulation performance, and the improvement of the resistivity of the electrode piece is due to the synergistic effect of the conductive agent and the first material. If the resistivity of the first material is too small, the first material itself already has good conductivity, which is not conducive to improving the impedance of the short-circuit site.

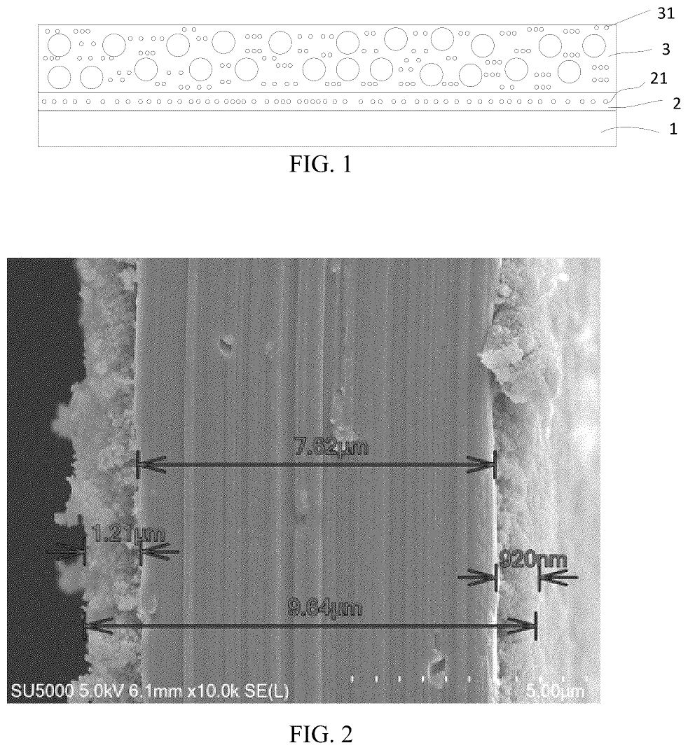

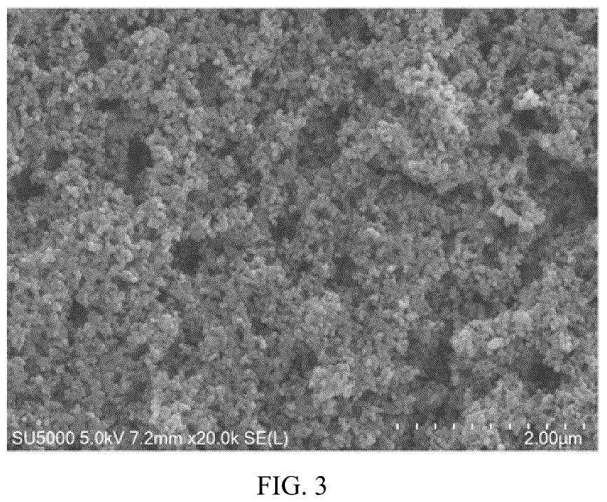

A cross-sectional electron micrograph and a surface electron micrograph of the first coating layer are shown in FIG. 2 and FIG. 3, where the coating has a thickness close to 1 μm. After the electrode piece containing the first coating layer is rolled, the thickness of the coating is less than 1 μm, where the particles of the first material are nano-sized, which may achieve the effect of thin coating.

As an embodiment, the positive electrode active material layer contains a second material and a second conductive agent. At this time, in the process of mechanical abuse, even if a contact short-circuit between the first coating layer and the negative electrode active material layer occurs, the second material in the positive electrode active material layer moves non-directionally, and part of the second material 31 is filled into the short circuit site, and synergizes with the first coating layer 2 to improve the impedance of the contact short-circuit site between the positive electrode current collector and the negative electrode active material and to reduce the heat generated by the short circuit, thereby effectively reducing the safety problems such as battery cell catching fire caused by the contact short-circuit between the positive electrode current collector and the negative electrode active material.

In addition, in the case where the positive electrode active material layer containing the second material synergizes with the first coating layer, when the thickness of the first coating layer is set to be relatively thin, it is it is also possible to improve the impedance of the contact short-circuit site between the positive electrode current collector and the negative electrode active material and reduce the heat generated by the short circuit, and meanwhile reduce the influence on the rate performance (for example discharge rate performance), cycle performance and other electrical performance of the battery cell due to addition of the first coating layer into the positive electrode piece. In an embodiment, the thickness of the first coating layer in the electrode piece is no greater than 1 μm.

As an embodiment, the positive electrode active material layer further contains a second binder, and a content of the second binder in the positive electrode active material layer is 0.5-5 wt %, and as another embodiment, a content of the second binder in the positive electrode active material layer is 3-5 wt %, which is more conducive to adhesion.

As shown in FIG. 1, the first coating layer 2 contains a first material 21, and a resistivity of the first material is greater than or equal to 1 Ω·cm. This is because that the improvement of the resistivity of the electrode piece is due to the synergistic effect of the conductive agent and the first material, and if the resistivity of the first material is too small, the first material itself already has good conductivity, which in turn also makes the sheet resistance of the electrode piece too small.

In the present disclosure, types of the first material and the second material are not limited, and as long as the resistivity of the first material is greater than or equal to 1 Ω·cm, and the resistivity of the second material is greater than or equal to 1 Ω·cm, the requirements of the present disclosure for the materials can be satisfied. The resistivity of the first material and the second material may be the same or different.

As an embodiment, the first material and the second material independently include, but are not limited to, one of: aluminum oxide, barium sulfate, silicon dioxide, silicon monoxide, zirconium oxide, magnesium oxide, vanadium oxide, titanium oxide, boehmite, which are carbon-coated or non-carbon-coated; carbon-coated or non-carbon-coated lithium iron manganese phosphate; and carbon-coated or non-carbon-coated lithium titanate, or a combination of two or more thereof.

Where a carbon content in carbon-coated lithium iron manganese phosphate or lithium titanate is ≤0.5%. A material with this carbon content is generally considered to be a low carbon-coated material.

Further, silicon dioxide, zirconium dioxide, aluminium oxide and magnesium oxide, etc., may be fumed silicon dioxide, fumed zirconium dioxide, fumed aluminium oxide and fumed magnesium oxide, etc., respectively. Fumed silicon dioxide, fumed zirconium dioxide, fumed aluminium oxide and fumed magnesium oxide, etc., have smaller particle diameter due to the preparation method, so that the first coating layer may be set thinner, and particles per unit mass can be dislodged from the positive electrode active material layer more and move non-directionally to fill into the short-circuit site, and thus the first coating can reduce the heat generated by the short-circuit, thereby effectively reducing safety problems such as battery cell catching fire caused by the short circuit.

As an embodiment, the first material and the second material may be the same or different. In an embodiment, the second material has a hydrophobic property, and for example, when the first material is different from the second material, a hydrophilic group on the surface of the second material may be transformed into a hydrophobic group through grafting treatment, such as a silane-based hydrophobic group, to enhance the dispersibility of the second material in an organic solvent (such as NMP) facilitating the preparation of a slurry for the active material layer.

In the present disclosure, the first conductive agent is not particularly limited, and the present disclosure can be realized by any commercially available conductive agent. For example, the first conductive agent includes, but is not limited to, one or more of carbon black, carbon tube, graphene, conductive metal powder, and conductive polymer. The carbon black may be Ketjen black. The conductive metal powder includes, but is not limited to, one or more of nickel, iron, cobalt, silver, copper, and the like. The conductive polymer includes, but is not limited to, one or more of polyacetylene, poly(nitrogen sulfide), polypyrrole, polythiophene, polyphenylene, polyphenylacetylene, polyaniline, and the like.

As an embodiment, the first material is a nano-scaled particle. It can be understood by those skilled in the art that, in the case where the content of the first material in the first coating layer is determined, the smaller the median particle diameter of the first protective material is, the thinner the thickness of a coating layer obtained by coating is, the more uniform the distribution of the insulating particles and the conductive agent is, and the smoother the coating layer is. It is conductive to realizing that the thickness of the first coating layer in the electrode piece is not greater than 1 μm.

In an embodiment of the first material, the first binder is a water-based binder. Since the positive electrode active material layer generally uses an oil-based binder, the use of the water-based binder in the first coating layer may prevent the oil-based binder in the positive electrode active material layer from dissolving the first coating layer in the process of coating the positive electrode active material layer, thereby ensuring the stability of the first coating layer. Furthermore, the use of the water-based binder in the first coating layer can avoid the increase of the interface impedance of the battery cell in a later stage of cycle caused by swelling of the first coating layer and the negative electrode active material layer, ensuring that the first coating layer has little influence on the internal resistance of the battery cell, and thus the first coating layer with the water-based binder improves the cycle stability of the battery cell.

Commercially available water-based binders can meet the requirement of the present disclosure. Specifically, the water-based binder includes, but is not limited to, one or more of sodium polyacrylate, calcium polyacrylate, lithium polyacrylate, polyacrylic acid, sodium carboxymethyl cellulose, lithium carboxymethyl cellulose, styrene-butadiene rubber, and the like.

In the positive electrode piece of the present disclosure, the positive electrode active material layer containing the second material synergizes with the first coating layer containing a specific sheet resistance. In this case, the first coating layer may be set to be relatively thin, for example, the thickness of the first coating layer is not greater than 1 μm, which can also improve the impedance of the contact short-circuit site between the positive electrode current collector and the negative electrode active material and reduce the heat generated by the short circuit, satisfying the requirement for the safety of the battery cell. Meanwhile, since the thickness of the first coating layer is relatively thin, the influence of the first coating layer on the rate performance, cycle performance and other electrical performance of the battery cell is reduced. In addition, it is ensured that the thickness of the first coating layer is not greater than 1 μm, to reduce a volume ratio of the first coating layer as much as possible, which is conducive to improving the energy density of the battery cell.

In addition, it may be understood by those skilled in the art that since the first coating layer has a larger roughness, a surface area of the first coating layer is larger than that of the positive electrode current collector, so that a contact area of the positive electrode active material layer with the first coating layer is much larger than that of the positive electrode active material layer with the positive electrode current collector. Therefore, compared to the positive active material layer being disposed on the surface of the positive electrode current collector, the first coating layer being disposed on the surface of the positive electrode current collector provides more transmission paths for charges. Therefore, under dual effects of thinner coating and larger specific surface area, the first coating layer has little influence on the rate performance (especially discharge rate performance) and cycle performance of the battery cell in normal use.

As an embodiment, the thickness of the first coating layer is not greater than 1 μm, further less than or equal to 0.6 μm, and more further greater than or equal to 0.2 m and less than or equal to 0.6 μm. For example, the thickness of the first coating layer is 0.9 μm, 0.8 μm, 0.7 μm, 0.6 μm, 0.5 μm, 0.4 μm, 0.3 μm, or a range consisting of any two thereof. Although the sheet resistance of the first coating layer is large, the first coating layer has little influence on the rate performance (for example, discharge rate performance) and cycle performance of the battery cell when the thickness of the first coating layer is not greater than 1 μm. Furthermore, the first coating layer with thickness of not greater than 1 μm cooperates with the positive electrode active material layer containing the second material, so that when the contact short-circuit between the positive electrode current collector and the negative electrode active material occurs, a dynamic contact impedance of the contact short-circuit site between the positive electrode current collector and the negative electrode active material is improved and the heat generated by the short circuit is reduced, thereby effectively reducing the safety problems such as battery cell catching fire caused by the short circuit, and almost having no influence on the rate performance (for example, discharge rate performance), cycle performance and other performance of the battery cell.

The influence of the first coating layer in the above thickness range and the positive electrode active material layer containing the second material on the rate performance (for example, discharge rate performance), cycle performance and other performance of the battery cell is significantly smaller than the influence of the first coating layer with a larger thickness (typically, thickness of the first coating layer alone is 3-5 μm) and the positive electrode active material layer containing no second material on the rate performance (for example, discharge rate performance), cycle performance and other performance of the battery cell. As an embodiment, a content of the second material in the positive electrode active material layer is greater than or equal to 0.8 wt %, and the positive electrode active material layer further contains a second conductive agent, and a content of the second conductive agent in the positive electrode active material layer is 0.3-3 wt %. By adjusting the contents of the second material and the second conductive agent in the positive electrode active material layer, the influence of the second material on the conductivity of the positive electrode active material layer is reduced, and meanwhile, when the contact short-circuit between the positive electrode current collector and the negative electrode active material occurs due to mechanical abuse, the second material in the positive electrode active material layer can move non-directionally, so that enough particles of the second material move and are filled into the short-circuit site, and synergize with the first coating layer with a specific sheet resistance to improve the impedance of the contact short-circuit site between the positive electrode current collector and the negative electrode active material, and reduce the heat generated by the short circuit, thereby effectively reducing the safety problems such as battery cell catching fire caused by the short circuit.

As an embodiment, the content of the second material in the positive electrode active material layer is greater than or equal to 1.5% wt and less than or equal to 5% wt; and the content of the second conductive agent in the positive electrode active material layer is 0.5 to 1.5 wt %. Then the conductive performance of the positive electrode active material layer is further optimized, and the impedance effect of the second material on the contact short-circuit site between the positive electrode current collector and the negative electrode active material is improved.

In the present disclosure, the second conductive agent is not particularly limited, and the present disclosure can be realized by any commercially available conductive agent. For example, the second conductive agent includes, but is not limited to, one or more of carbon black, carbon tube, graphene, conductive metal powder, conductive polymer, and the like. The carbon black may be Ketjen black. The conductive metal powder includes, but is not limited to, one or more of nickel, iron, cobalt, silver, copper, and the like. The conductive polymer includes, but is not limited to, one or more of polyacetylene, poly(nitrogen sulfide), polypyrrole, polythiophene, polyphenylene, polyphenylacetylene, polyaniline, and the like.

As an embodiment, the first conductive agent and the second conductive agent may be the same or different.

As an embodiment, the second material is a nano-scaled particle. It can be understood by those skilled in the art that, in the case where the content of the second material in the positive electrode active material layer is determined, the smaller the median particle diameter of the second material is, the more the second material contained in the positive electrode active material layer is, and the better the effect of improving the impedance of the contact short-circuit site between the positive electrode current collector and the negative electrode active material and reducing the heat generated by the short circuit is.

As an embodiment, the median particle diameter of the second material is: Dv50≤800 nm, further Dv50≤400 nm, and further 10 nm≤Dv50≤80 nm. For example, the median particle diameter of the second material, Dv50, is 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 10 nm, or a range consisting of any two thereof.

As an embodiment, the positive electrode active material layer further contains a second binder, and a content of the second binder in the positive electrode active material layer is 0.5 to 5 wt %.

As an embodiment, the second binder may be an oil-based binder. The oil binder sold in the market may meet the requirement of the present disclosure. Specifically, the oil-based binder includes, but is not limited to, one or more of poly(vinylidene fluoride), polytetrafluoroethylene, polymethacrylate, sodium carboxymethyl cellulose, polyacrylonitrile multicopolymer, polyamide, polyacrylic acid, polyvinyl ether, acrylonitrile-butadiene rubber, styrene-butadiene rubber, and the like.

As an embodiment, the positive electrode active material layer further contains a positive electrode active material, and a content of the positive electrode active material in the positive electrode active material layer is 90-97 wt %. When the content of the positive electrode active material is within this range, the capacity of the battery cell having the positive electrode piece is ensured.

In the present disclosure, the positive electrode active material is not particularly limited. Commercially available positive electrode active materials may meet the requirement of the positive electrode current collector of the present disclosure. For example, the positive electrode active material (the positive electrode active substance) includes, but is not limited to, one or more of lithium cobaltate, lithium iron phosphate, lithium nickelate, lithium manganate, lithium titanate, lithium vanadate, lithium manganese phosphate, lithium manganese iron phosphate, lithium vanadium phosphate, lithium oxyvanadium phosphate, lithium-rich manganese material, nickel-cobalt-manganese ternary material, nickel-cobalt-aluminum ternary material, nickel-cobalt-manganese-aluminum material, nickel-manganese binary material and sodium-containing lithium cobaltate material.

The positive electrode current collector is not particularly limited in the present disclosure. Commercially available positive electrode current collectors may meet the requirement of the positive electrode current collector of the present disclosure. For example, the positive electrode current collector may be a metallic foil or a metallic/non-metallic composite foil. The metallic foil includes but is not limited to aluminum foil, nickel foil, and the like. The metallic composite foil refers to a current collector with a sandwich structure, where a middle layer of the sandwich structure is a polymer layer, which may be selected from one of common polymer materials such as polyethylene, polyvinyl chloride, polypropylene, polyethylene terephthalate, etc.; and two surfaces of the polymer layer are formed into metal conductive layers by means of sputtering, etc., where the metal includes but is not limited to aluminum, nickel, etc. The positive electrode current collectors should not be subjected to a carbon coating process, so as to avoid the risk of mechanical abuse due to the reduction of impedance by the carbon coating layer. The carbon coating process refers to setting a carbon-coated coating layer with a conductive agent content of >30% on a surface of the current collector, but the coating layer can be subjected to surface passivation, roughening, high temperature or other treatment.

As an embodiment, the positive electrode active material layer may be a single-layer coated or a double-layer coated, and the double-layer positive electrode may be generally used to improve the capacity of the positive electrode or the rate discharge performance. The second materials, the positive electrode active materials, the second binders, and the second conductive agents in different positive electrode active material layers may be the same or different.

A second aspect of the present disclosure provides a method for preparing the positive electrode piece as described above, including the following steps:
forming a first coating layer on at least one surface of a positive electrode current collector;
preparing a second slurry containing a second material and a positive electrode active material; and
coating the second slurry on a surface of the first coating layer, and then drying, to obtain a positive electrode active material layer, to obtain a positive electrode piece.

As an embodiment, the first coating layer is prepared by the following steps: preparing a first slurry containing a first material; and coating the first slurry on the at least one surface of the positive electrode current collector, and then drying, to obtain the first coating layer.

The present disclosure provides a battery cell, including the positive electrode piece as described above or the positive electrode piece prepared by the above method.

The battery cell with the positive electrode piece as described above or the positive electrode piece prepared by the above method can improve the impedance of the contact short-circuit site between the positive electrode current collector and the negative electrode active material and reduce the heat generated by the short-circuit, thereby effectively reducing safety problems such as battery cell catching fire caused by the short circuit.

As an embodiment, the battery cell further includes a negative electrode piece, a separator and an electrolyte.

As an embodiment, the negative electrode piece includes a negative electrode current collector and a negative electrode active material layer.

As an embodiment, the negative electrode current collector includes, but is not limited to, a copper foil, a nickel foil, a stainless steel foil, or the like.

As an embodiment, the negative electrode active material layer includes a negative electrode active material, a binder, and a conductive agent.

As an embodiment, the negative electrode active material in the negative electrode active material layer includes, but is not limited to, one or more of graphite, hard carbon, soft carbon, pure silicon, silicon carbon, silicon oxygen, silicon alloy, metal lithium, metal germanium, and the like. Graphite may be natural graphite or artificial graphite.

As an embodiment, the binder in the negative electrode active material layer includes, but is not limited to, one or more of sodium carboxymethyl cellulose, styrene-butadiene rubber, polyacrylic acid, sodium polyacrylate, lithium polyacrylate, and the like.

As an embodiment, the conductive agent in the negative electrode active material layer includes, but is not limited to, one or more of carbon black, carbon tube, graphene, conductive metal powder, conductive polymer, and the like. The carbon black may be Ketjen black. The conductive metal powder includes, but is not limited to, one or more of nickel, iron, cobalt, copper, and the like. The conductive polymer includes, but is not limited to, one or more of polyacetylene, polypyrrole, polythiophene, polyphenylene, polyphenylacetylene, polyaniline, and the like.

As an embodiment, the negative electrode active material layer may be one layer, two layers or more layers. The negative electrode active materials, the binders, and the conductive agents in different negative electrode active material layers may be the same or different.

As an embodiment, a material of the separator includes, but is not limited to, one or more of polypropylene, polyethylene terephthalate, polyimide, non-woven fabric, aramid, and the like.

As an embodiment, at least one surface of the separator is provided with an inorganic particle, and the inorganic particle includes, but is not limited to, one or more of aluminium oxide, boehmite, magnesium oxide, titanium oxide, silicon oxide, barium sulfate, and the like. The binder in the separator includes, but is not limited to, one or more of polyacrylonitrile, poly(vinylidene fluoride), polytetrafluoroethylene, sodium carboxymethyl cellulose, polyacrylic acid, lithium polyacrylate, and the like.

As an embodiment, the electrolyte includes, but is not limited to, a liquid electrolyte, a semi-solid electrolyte, or a solid electrolyte.

A second aspect of the present disclosure provides a lithium-ion battery, including the positive electrode piece as described above.

Where the lithium-ion battery further includes a negative electrode piece, the negative electrode piece includes a negative electrode current collector, and a first negative electrode active layer and a second negative electrode active layer both of which are located on at least one surface of the negative electrode current collector, where the first negative electrode active layer is located between the second negative electrode active layer and the current collector; as an embodiment, a particle diameter of a negative electrode active material in the negative positive electrode active layer is larger than a particle diameter of a negative electrode active material in the second negative electrode active layer. This is conducive to further improving the electrochemical performance of the battery.

The lithium-ion battery with the above battery cell can improve the impedance of the contact short-circuit site between the positive electrode current collector and the negative electrode active material in a mechanical abuse process and reduce the heat generated by the short circuit, thereby effectively reducing safety problems such as battery cell catching fire caused by the short circuit, and meanwhile, the first coating layer in the positive electrode piece does not need to be set very thick in order to achieve a good safety effect, thereby reducing the influence of addition of the first coating layer to the positive electrode piece on the rate performance (for example, discharge rate performance), cycle performance and other electrical performance of the battery cell.

The positive electrode material and the lithium-ion battery of the present disclosure are described in detail below through specific examples.

### Example 1

Hydrophilic fumed silicon dioxide with a Dv50 of 15 nm (first material), lithium polyacrylate binder and carbon black conductive agent were added into deionized water at a mass ratio of 55:40:5. The powder resistivity of the hydrophilic fumed silicon dioxide was greater than 1E+4 Ω·cm. An ultra-thin safety coating slurry with a solid content of 8% was obtained after high-speed stirring. The slurry was coated on upper and lower surfaces of aluminum foil with a thickness of 10 μm using a 160 mesh gravure roller, and then dried in an oven at 70° C. to obtain an ultra-thin safety coating layer with a single-sided coating surface density of 0.0002 g/cm², which was a first coating layer. The coating layer was tested using an electrode piece resistance tester, and the sheet resistance was about 4500 mΩ/□.

Lithium cobaltate with a Dv50 of 15 μm, hydrophobic silicon dioxide with a Dv50 of 20 nm (second material), poly(vinylidene fluoride), carbon black and carbon tube were added to N-methylpyrrolidone (NMP) at a mass ratio of 94:3:2:0.8:0.2. A slurry of a positive active material layer containing the second material and with a solid content of 65% was obtained after high-speed stirring. The powder resistivity of the hydrophobic silicon is greater than 1E+4 Ω·cm. The slurry was coated on surfaces of the two first coating layers respectively using a squeezing coater to obtain a pre-prepared positive electrode piece containing the first coating layers and a positive electrode active material layer containing the second material. The pre-prepared positive electrode piece was dried in an oven at 105° C., and then was rolled and cut to obtain the positive electrode piece where a thickness of the ultra-thin safety coating layer after rolling was about 1.0 μm and a thickness of the positive electrode active material layer containing the second material after rolling was 50 μm.

A negative electrode slurry was prepared from an artificial graphite with a Dv50 of 15 μm, styrene-butadiene rubber, and sodium carboxymethyl cellulose at a mass ratio of 98:1.5:0.5 and was coated on two surfaces of a copper foil, baked at 95° C., and then rolled and cut to obtain a negative electrode piece.

Ethyl methyl carbonate, diethyl carbonate and ethylene carbonate were prepared into a mixed solvent at a volume ratio of 1:1:1. LiPF₆ was selected as a lithium salt, and an appropriate amount of LiPF₆ was added into the solvent to obtain an electrolyte with a lithium salt content of 1 μmol/L.

The prepared positive electrode piece, the prepared negative electrode piece, and a separator and the like were sequentially wound to form a wound core, and the winding core was subjected to packaging, code spraying, liquid injection, standing, formation, sorting and other process to obtain a safety-improved lithium-ion battery with a model number of 455483, an upper limit voltage of 4.45 V and a capacity of 4400 mAh.

### Example 2

The preparation process of this example was basically the same as that of Example 1, except that the mass ratio of hydrophilic fumed silicon dioxide, lithium polyacrylate binder and carbon black conductive agent in the first coating layer was 58:38:20. The remaining conditions were not changed. The sheet resistance of the first coating layer after baking was about 800 mΩ/□.

### Example 3

The preparation process of this example was basically the same as that of Example 1, except that the mass ratio of hydrophilic fumed silicon dioxide, lithium polyacrylate binder and carbon black conductive agent in the first coating layer was 58:40:2. The remaining conditions were not changed. The sheet resistance of the first coating layer after baking was about 1300 mΩ/□.

### Example 4

The preparation process of this example was basically the same as that of Example 1, except that the mass ratio of lithium cobaltate, hydrophobic silicon dioxide, poly(vinylidene fluoride), carbon black and carbon tube in the positive electrode active material layer was 90:7:2:0.8:0.2. The remaining conditions were not changed.

### Example 5

The preparation process of this example was basically the same as that of Example 1, except that the mass ratio of lithium cobaltate, hydrophobic silicon dioxide, poly(vinylidene fluoride), carbon black and carbon tube in the positive electrode active material layer was 80:15:4:0.8:0.2. The remaining conditions were not changed.

### Example 6

The preparation process of this example was basically the same as that of Example 1, except that the positive electrode contained a double-layer active material layer, where the conductive agent on a side close to the current collector had a higher content and the mass ratio of lithium cobaltate, hydrophobic silicon dioxide, poly(vinylidene fluoride), carbon black and carbon tube was 93.5:3:2:1.3:0.2; and the active material on a side close to the separator had a higher content and the mass ratio of lithium cobaltate, hydrophobic silicon dioxide, poly(vinylidene fluoride), carbon black and carbon tube was 94.2:3:2:0.6:0.2. The surface density of the first active material layer and the second active material layer was basically the same. The remaining conditions were not changed.

### Example 7

The preparation process of this example was basically the same as that of Example 1, except that the negative electrode contained a double-layer active material layer, where a side close to the current collector adapted artificial graphite with a Dv50 of 15 μm and a side close to the separator adapted small particle artificial graphite with a Dv50 of 9 μm. The surface density of the first active material layer and the second active material layer was basically the same. The remaining conditions were not changed.

### Example 8

The preparation process of this example was basically the same as that of Example 1, except that the coating surface density of the first coating layer was 0.0001 g/cm². The remaining conditions were not changed, the sheet resistance of the first coating layer was about 2000 mΩ/□, and the thickness of the first coating layer in the electrode piece was about 0.5 μm after the positive electrode active material layer was coated and rolled.

### Example 9

The preparation process of this example was basically the same as that of Example 1, except that the protective material in the first coating layer was nano-aluminium oxide with a slightly carbon coated surface, the powder resistivity of the carbon-coated nano-aluminium oxide was about 1 Ω·cm, and the mass ratio of carbon-coated nano-aluminium oxide and lithium polyacrylate binder was 60:40. The sheet resistance of the first coating layer was about 500 mΩ/□.

### Example 10

The preparation process of this example was basically the same as that of Example 1, except that hydrophilic fumed silicon dioxide with a Dv50 of 15 nm (first material) was replaced by hydrophilic fumed silicon dioxide with a Dv50 of 50 nm. The remaining conditions were not changed. A coating layer with a single-sided coating surface density of 0.0002 g/cm² was obtained. The coating layer was tested with an electrode piece resistance tester, and the sheet resistance was about 4000 mΩ/□.

### Example 11

The preparation process of this example was basically the same as that of Example 1, except that hydrophilic fumed silicon dioxide with a Dv50 of 15 nm (first material) was replaced by hydrophilic fumed silicon dioxide with a Dv50 of 100 nm. The remaining conditions were not changed. A coating layer with a single-sided coating surface density of 0.0002 g/cm² was obtained. The coating layer was tested with an electrode piece resistance tester, and the sheet resistance was about 3400 mΩ/□.

### Example 12

The preparation process of this example was basically the same as that of Example 1, except that hydrophilic fumed silicon dioxide with a Dv50 of 15 nm (first material) was replaced by hydrophilic fumed silicon dioxide with a Dv50 of 200 nm. The remaining conditions were not changed. A coating layer with a single-sided coating surface density of 0.0002 g/cm² was obtained. The coating layer was tested with an electrode piece resistance tester, and the sheet resistance was about 4000 mΩ/□.

### Example 13

The preparation process of this example was basically the same as that of Example 1, except that hydrophilic fumed silicon dioxide with a Dv50 of 15 nm (first material) was replaced by hydrophilic fumed silicon dioxide with a Dv50 of 400 nm. The remaining conditions were not changed. A coating layer with a single-sided coating surface density of 0.0002 g/cm² was obtained. The coating layer was tested with an electrode piece resistance tester, and the sheet resistance was about 2500 mΩ/□.

### Example 14

The preparation process of this example was basically the same as that of Example 1, except that hydrophilic fumed silicon dioxide with a Dv50 of 15 nm (first material) was replaced by hydrophilic fumed silicon dioxide with a Dv50 of 500 nm. The remaining conditions were not changed. A coating layer with a single-sided coating surface density of 0.0002 g/cm² was obtained. The coating layer was tested with an electrode piece resistance tester, and the sheet resistance was about 2000 mΩ/□.

### Example 15

The preparation process of this example was basically the same as that of Example 1, except that hydrophilic fumed silicon dioxide with a Dv50 of 15 nm (first material) was replaced by hydrophilic fumed silicon dioxide with a Dv50 of 800 nm. The remaining conditions were not changed. A coating layer with a single-sided coating surface density of 0.0002 g/cm² was obtained. The coating layer was tested with an electrode piece resistance tester, and the sheet resistance was about 1200 mΩ/□.

### Example 16

The preparation process of this example was basically the same as that of Example 1, except that the mass ratio of lithium cobaltate, hydrophobic silicon dioxide, poly(vinylidene fluoride), carbon black and carbon tube in the positive electrode active material layer was 97:0:2:0.8:0.2. The remaining conditions were not changed.

### Comparative Example 1

The comparative example differs from Example 1 in that there was no first coating layer in the positive electrode piece, and the mass ratio of lithium cobaltate, hydrophobic silicon dioxide, poly(vinylidene fluoride), carbon black and carbon tube in the positive electrode active material layer was 97:0:2:0.8:0.2.

### Comparative Example 2

The preparation process of this comparative example was basically the same as that of Example 1, except that there was no ultra-thin safety coating layer (i.e., no first coating layer) in the positive electrode piece. The remaining conditions were not changed.

### Comparative Example 3

The preparation process of this comparative example was basically the same as that of Example 1, except that hydrophilic fumed silicon dioxide with a Dv50 of 15 nm was replaced by aluminium oxide with a Dv50 of 900 nm. The remaining conditions were not changed. A coating layer with a single-sided coating surface density of 0.0002 g/cm² was obtained. The coating layer was tested with an electrode piece resistance tester, and the sheet resistance was about 1000 mΩ/□.

### Comparative Example 4

The preparation process of this comparative example was basically the same as that of Example 1, except that hydrophilic fumed silicon dioxide with a Dv50 of 15 nm (first material) was replaced by aluminium oxide with a Dv50 of 1200 nm. The remaining conditions were not changed. A coating layer with a single-sided coating surface density of 0.0002 g/cm² was obtained. The coating layer was tested with an electrode piece resistance tester, and the sheet resistance was about 700 mΩ/□.

### Comparative Example 5

The preparation process of this comparative example was basically the same as that of Example 1, except that the mass ratio of hydrophilic fumed silicon dioxide, lithium polyacrylate binder and carbon black conductive agent in the first coating layer was 40:30:30. The remaining conditions were not changed. The sheet resistance of the first coating layer after baking was about 200 mΩ/□.

### TEST EXAMPLES

### 1. Nail Penetration Test

In each group, 10 pcs fresh batteries were charged to a full charge of 4.45 V at 0.5 C, and then charged to 0.05 C at a constant voltage of 4.45V. Nail-penetration was made using tungsten steel needle with a diameter of 4 mm and a tip length of 4.5 mm to vertically pierce through a geometric center of a battery cell of a battery at a speed of 30 mm/s, and the steel needle was kept inside the battery for 10 min and then pulled out. During this period, if the battery did not smoke, fire or explode, then it was deemed to have passed.

### 2. Cycle Test

In each group, 3 pcs fresh batteries were cycled for 1000 T at a charge-discharge regime of 1 C/0.5 C. The capacity after 1000 T was divided by a sorted capacity, and an average value of 3 pcs was taken as a cycle retention rate of the batteries.

### 3. 1 C Rate Charging Test

In each group, 3 pcs fresh batteries were charged to 4.48 V in a constant current and constant voltage mode at 1 C, and a cut-off current was 0.02 C. A capacity ratio of the constant current stage to the constant voltage stage was calculated as the constant current charging ratio of a rate charging stage.

### 4. 2C Rate Discharging Test

In each group, 3 pcs fresh batteries were discharged to 4.48 V in a constant current and constant voltage mode at 1 C, and a cut-off current was 0.02 C. After standing for 10 min, the batteries were discharged to 3.0 V at discharge rate of 2 C. The discharge capacity was divided by the initial capacity, to obtain a constant current discharge capacity retention rate.

### 5. Internal Resistance Test

HIOKI BT3554 type internal resistance meter was used to test an internal resistance of a battery in fully charged state.

### 6. Resistivity Test of Particles of the First Material and the Second Material

A certain mass of resistance-increasing particles was put into a die cavity of a powder resistance tester through a funnel. The powder of particles of the first material and the second material was compacted by a force of 20 KN. A resistance value of the powder to be measured was automatically measured by software, and then a thickness of the compacted powder was input to obtain a powder resistivity of particles of the first material and the second material.

### 7. Sheet Resistance Test

An electrode piece, both surfaces of which were coated with the first coating layer and not coated with the positive electrode active material layer, was placed in a test area of an electrode piece resistance tester. The test head of the tester was upper and lower two copper round rods, with a downward pressure of 4 KN. A ratio of data obtained after the corresponding downforce was reached and stabilized to an area of the round rods was regarded as a sheet resistance of the electrode piece, in mΩ/□ as unit.

TABLE 1

| | | | Sheet | | | | Constant | |
|---|---|---|---|---|---|---|---|---|
| | | | resistance | Internal | | | current | |
| | | | of first | resistance | Passing rate | | discharge | Constant |
| | First | Second | coating | of battery | of | Cycle | capacity | current |
| | material | material | layer | cell | acupuncturing | retention | retention | charging |
| No. | Dv50/nm | Dv50/nm | mΩ/□ | mΩ | test | rate | rate | ratio |
| Example 1 | 15 | 20 | 4500 | 33.69 | 10/10 | 88.35% | 76.21% | 66.43% |
| Example 2 | 15 | 20 | 800 | 33.47 | 9/10 | 88.65% | 77.06% | 66.50% |
| Example 3 | 15 | 20 | 13000 | 34.81 | 10/10 | 84.25% | 73.62% | 65.31% |
| Example 4 | 15 | 20 | 4500 | 33.93 | 10/10 | 86.30% | 75.33% | 66.34% |
| Example 5 | 15 | 20 | 4500 | 35.25 | 10/10 | 86.23% | 75.61% | 66.12% |
| Example 6 | 15 | 20 | 4500 | 33.36 | 10/10 | 88.44% | 76.87% | 66.73% |
| Example 7 | 15 | 20 | 4500 | 33.61 | 10/10 | 88.53% | 76.40% | 67.32% |
| Example 8 | 15 | 20 | 2000 | 33.45 | 10/10 | 88.76% | 76.71% | 67.58% |
| Example 9 | 15 | 20 | 500 | 33.51 | 9/10 | 88.82% | 76.48% | 67.49% |
| Example 10 | 50 | 20 | 4000 | 33.62 | 10/10 | 88.32% | 76.29% | 66.49% |
| Example 11 | 80 | 20 | 3400 | 33.57 | 10/10 | 88.44% | 76.33% | 66.54% |
| Example 12 | 100 | 20 | 4000 | 33.60 | 10/10 | 88.39% | 76.31% | 66.55% |
| Example 13 | 200 | 20 | 2500 | 33.49 | 10/10 | 88.43% | 76.42% | 66.61% |
| Example 14 | 500 | 20 | 2000 | 33.40 | 9/10 | 88.47% | 76.49% | 66.79% |
| Example 15 | 800 | 20 | 1200 | 33.34 | 8/10 | 88.53% | 76.53% | 66.94% |
| Example 16 | 15 | / | 4500 | 33.40 | 6/10 | 89.07% | 76.31% | 66.69% |
| Comparative | / | / | / | 33.42 | 0/10 | 85.26% | 73.54% | 66.81% |
| example 1 | | | | | | | | |
| Comparative | / | 20 | / | 33.56 | 4/10 | 84.49% | 73.35% | 66.60% |
| example 2 | | | | | | | | |
| Comparative | 900 | 20 | 1000 | 33.31 | 5/10 | 84.71% | 73.30% | 67.05% |
| example 3 | | | | | | | | |
| Comparative | 1200 | 20 | 700 | 33.26 | 1/10 | 84.79% | 73.68% | 67.21% |
| example 4 | | | | | | | | |
| Comparative | 15 | 20 | 200 | 33.32 | 4/10 | 84.72% | 74.49% | 66.59% |
| example 5 | | | | | | | | |

It can be seen from Examples 1-16 and Comparative examples 1-2 that the batteries without the first material doped in the first coating layer were unable to pass the nail penetration test. It can be seen from Examples 1-15 and Example 16 that the batteries with the first material and the second material doped in the first coating layer and the active material layer, respectively, were able to further improve the passing rate of the nail penetration test of the batteries.

It can be seen from Examples 1-16 and Comparative examples 3, 4 and 5 that, when the particle diameter of the first material being ≤800 nm and the sheet resistance of the first coating layer being not less than 500 mΩ/□ were simultaneously satisfied, the influence on the electrochemical performance of the lithium-ion battery was minimized while ensuring the safety performance; and if the particle diameter of the first material, Dv50, was >800 nm, or the sheet resistance of the first coating layer was less than 500 mΩ/□, the safety was poor.

It can be seen from Examples 1 and 2 and Comparative Example 3 in the above examples that after the conductivity of the ultra-thin safety coating layer (the first coating layer) was improved, the passing rate of the nail penetration test was significantly reduced, indicating that the resistance-increasing treatment on the surface close to the aluminum foil was the key to improving the mechanical abuse; when the range of the conductivity was beyond the scope of the present application, it was not conducive to improving the passing rate of the nail penetration test. It can be seen from Examples 1 and 3 that when the conductivity of the first coating layer was further reduced, the cycle performance was affected to a certain extent due to increase of the impedance. It can be seen from the comparison of Examples 1, 4, 5 and 16 that the second material in the positive electrode active material layer had a great contribution to the improvement of safety. It can be seen from the comparison of Example 1 and Comparative example 2 that simply adding the second material in the active material layer had a poor improvement effect. It can be seen from the comparison of Examples 1, 6 and 7 that the rate performance was improved to some extent by using a double-layer active material structure for the positive and negative electrodes. It can be seen from the comparison of Examples 1 and 8 that the battery cell still can pass the mechanical abuse test (i.e., nail penetration test) when reducing the thickness of the first coating layer in the positive electrode piece to 0.5 m by reducing the coating surface density. It can be seen from the comparison of Examples 1 and 9 that using the carbon-coated aluminium oxide with a lower powder resistivity still ensured a high passing rate of mechanical abuse.

Finally, it should be explained that the above examples are merely used to illustrate the technical solutions of the present disclosure, rather than limit it; although the present disclosure is described in detail with reference to the foregoing examples, those of ordinary skill in the art should understand that they can still modify the technical solutions recorded in the foregoing examples, or equivalently substitute some or all of technical features therein; these modifications or substitutions do not make the essence of the corresponding technical solutions depart from the scope of the technical solutions of the examples of the present disclosure.

What is claimed is:

1. A positive electrode piece, comprising: a positive electrode current collector, a first coating layer disposed on at least one surface of the positive electrode current collector, and a positive electrode active material layer disposed on a surface of the first coating layer;
wherein the first coating layer contains a first material and a conductive agent, and a particle diameter of the first material, Dv50, is ≤800 nm; and
a sheet resistance of the first coating layer is not less than 500 mΩ/□.

2. The positive electrode piece according to claim 1, wherein the particle diameter of the first material, Dv50, is ≤400 nm; and/or
the sheet resistance of the first coating layer is not less than 800 mΩ/□; and/or
the sheet resistance of the first coating layer is ≤13000 mΩ/□.

3. The positive electrode piece according to claim 2, wherein the particle diameter of the first material, Dv50, satisfies: 10 nm≤Dv50≤80 nm; and/or
the sheet resistance of the first coating layer is not less than 800 mΩ/□; and/or
the sheet resistance of the first coating layer is ≤4000 mΩ/□.

4. The positive electrode piece according to claim 1, wherein in the first coating layer, a mass ratio of the first material is ≥30%, and a mass ratio of the conductive agent is ≤20%.

5. The positive electrode piece according to claim 4, wherein the first coating layer further contains a first binder, and a content of the first binder in the first coating layer is greater than or equal to 15 wt % and less than or equal to 70 wt %.

6. The positive electrode piece according to claim 1, wherein a thickness of the first coating layer in the positive electrode piece is not greater than 1 μm; and/or
a resistivity of the first material is greater than or equal to 1 Ω·cm.

7. The positive electrode piece according to claim 2, wherein a thickness of the first coating layer in the positive electrode piece is not greater than 1 μm; and/or
a resistivity of the first material is greater than or equal to 1 Ω·cm.

8. The positive electrode piece according to claim 3, wherein a thickness of the first coating layer in the positive electrode piece is not greater than 1 μm; and/or
a resistivity of the first material is greater than or equal to 1 Ω·cm.

9. The positive electrode piece according to claim 4, wherein a thickness of the first coating layer in the positive electrode piece is not greater than 1 μm; and/or
a resistivity of the first material is greater than or equal to 1 Ω·cm.

10. The positive electrode piece according to claim 1, wherein the positive electrode active material layer contains a second material and a positive electrode active material, wherein a resistivity of the second material is greater than or equal to 1 Ω·cm.

11. The positive electrode piece according to claim 2, wherein the positive electrode active material layer contains a second material and a positive electrode active material, wherein a resistivity of the second material is greater than or equal to 1 Ω·cm.

12. The positive electrode piece according to claim 3, wherein the positive electrode active material layer contains a second material and a positive electrode active material, wherein a resistivity of the second material is greater than or equal to 1 Ω·cm.

13. The positive electrode piece according to claim 4, wherein the positive electrode active material layer contains a second material and a positive electrode active material, wherein a resistivity of the second material is greater than or equal to 1 Ω·cm.

14. The positive electrode piece according to claim 1, wherein the first material is selected from at least one of: aluminum oxide, barium sulfate, silicon dioxide, silicon monoxide, zirconium oxide, magnesium oxide, vanadium oxide, titanium oxide, boehmite, which are carbon-coated or non-carbon-coated; carbon-coated or non-carbon-coated lithium iron manganese phosphate; and carbon-coated or non-carbon-coated lithium titanate.

15. The positive electrode piece according to claim 2, wherein the first material is selected from at least one of: aluminum oxide, barium sulfate, silicon dioxide, silicon monoxide, zirconium oxide, magnesium oxide, vanadium oxide, titanium oxide, boehmite, which are carbon-coated or non-carbon-coated; carbon-coated or non-carbon-coated lithium iron manganese phosphate; and carbon-coated or non-carbon-coated lithium titanate.

16. The positive electrode piece according to claim 3, wherein the first material is selected from at least one of: aluminum oxide, barium sulfate, silicon dioxide, silicon monoxide, zirconium oxide, magnesium oxide, vanadium oxide, titanium oxide, boehmite, which are carbon-coated or non-carbon-coated; carbon-coated or non-carbon-coated lithium iron manganese phosphate; and carbon-coated or non-carbon-coated lithium titanate.

17. The positive electrode piece according to claim 10, wherein the positive electrode active material comprises at least one of lithium cobaltate, lithium iron phosphate, lithium nickelate, lithium manganate, lithium titanate, lithium vanadate, lithium manganese phosphate, lithium manganese iron phosphate, lithium vanadium phosphate, lithium oxyvanadium phosphate, lithium-rich manganese material, nickel-cobalt-manganese ternary material, nickel-cobalt-aluminum ternary material, nickel-cobalt-manganese-aluminum material, nickel-manganese binary material and sodium-containing lithium cobaltate; and/or
the second material is selected from at least one of: aluminum oxide, barium sulfate, silicon dioxide, silicon monoxide, zirconium oxide, magnesium oxide, vanadium oxide, titanium oxide, boehmite, which are carbon-coated or non-carbon-coated; carbon-coated or non-carbon-coated lithium iron manganese phosphate; and carbon-coated or non-carbon-coated lithium titanate.

18. A lithium-ion battery, comprising the positive electrode piece according to claim 1.

19. The lithium-ion battery according to claim 18, wherein the lithium-ion battery further comprises a negative electrode piece, the negative electrode piece comprises a negative electrode current collector, and a first negative electrode active layer and a second negative electrode active layer which are located on at least one surface of the negative electrode current collector, wherein the first negative electrode active layer is located between the second negative electrode active layer and the negative electrode current collector.

20. The lithium-ion battery according to claim 19, wherein a particle diameter of a negative electrode active material in the first negative electrode active layer is larger than a particle diameter of a negative electrode active material in the second negative electrode active layer.
